(19) United States
(12) Patent Application Publication
(10) Pub. No.: US 2024/0416743 A1
(43) Pub. Date: Dec. 19, 2024

(54) VEHICLE WITH SIDE DUCTS FOR THE CONFINEMENT OF A CENTRAL HOT FLOW

(71) Applicant: FERRARI S.P.A., MODENA (MO) (IT)

(72) Inventors: Andrea PAOLINI, Modena (MO) (IT); Rubens Mauro CURATOLA, Modena (MO) (IT); Matteo BIANCALANA, Modena (MO) (IT)

(73) Assignee: FERRARI S.P.A., MODENA (MO) (IT)

(21) Appl. No.: 18/738,611

(22) Filed: Jun. 10, 2024

(30) Foreign Application Priority Data
Jun. 16, 2023 (IT) 102023000012393

(51) Int. Cl. B60K 11/04; B60H 1/28; B60K 13/02

(52) U.S. Cl. CPC B60K 11/04; B60H 1/28; B60K 13/02

(57) ABSTRACT

A vehicle has a front compartment obtained within an outer body and delimited by a front bumper and by a front hood, a central duct, which extends between the front bumper and the front hood and opens outwards both through the front bumper and through the front hood, a front radiator mounted along the central duct and two side ducts, which are arranged on opposite sides of the central duct, extend between the front bumper and the front hood and open outwards both through the front bumper and through the front hood so as to confine a central air flow supplied along the central duct between two side air flows supplied along the side ducts.

### CROSS-REFERENCE TO RELATED APPLICATIONS

This patent application claims priority from Italian patent application no. 102023000012393 filed on Jun. 16, 2023, the entire disclosure of which is incorporated herein by reference.

### TECHNICAL FIELD

The invention relates to a vehicle. The invention particularly advantageously applies to a hybrid vehicle provided with an internal combustion engine and with an electric motor, to which explicit reference will be made in the description below without because of this lacking generality.

### BACKGROUND

In the field of hybrid vehicles, a vehicle is known, which comprises a support frame defining part of a lower floor of the vehicle; a passenger compartment mounted on the support frame and projecting upwards from the lower floor; an outer body; a front compartment obtained within the outer body and delimited by a front bumper and by a front hood; and a rear compartment obtained within the outer body.

The vehicle is further provided with a main internal combustion engine accommodated in the rear compartment, with a compressor to supply compressed air to the main engine, with a heat exchanger to cool the air supplied by the compressor to the main engine and with a pair of intake mouths to supply air coming from the outside to the heat exchanger.

The vehicle further comprises at least one pair of additional intake mouths to connect the outside and the passenger compartment to one another; an air heating/conditioning system to heat/condition the air supplied to the passenger compartment through the additional intake mouths; and an auxiliary electric motor accommodated in the front compartment and associated with a front radiator mounted along a supply duct communicating with the outside.

The vehicle further comprises an aerodynamic bottom, which is fixed to the support frame, defines part of the lower floor and comprises, in turn, a front bottom, which is mounted in the area of the front compartment, a rear bottom, which is mounted in the area of the rear compartment, and a central bottom, which is mounted in the area of the passenger compartment.

Since the vehicle must be subject to a relatively large vertical load, the front bottom must be closed and the supply duct must extend through the front hood starting from the front bumper.

Known vehicles of the type described above suffer from some drawbacks, which are mainly due to the fact that the flow of air heated by the front radiator and supplied along the supply duct and through the front hood causes the heating of the air supplied through the aforesaid intake mouths and jeopardizes the correct operation of the heat exchanger and of the heating/conditioning system.

### SUMMARY

The object of the invention is to provide a vehicle that is not affected by the aforementioned drawbacks and can be manufactured in a simple and economic fashion.

According to the invention, there is provided a vehicle as claimed in the appended claims.

### BRIEF DESCRIPTION OF THE DRAWINGS

The invention will now be described with reference to the accompanying drawings showing a non-limiting embodiment thereof, wherein:

FIGS. 1 and 2 are two schematic perspective views, with parts removed for greater clarity, of a preferred embodiment of the vehicle according to the invention; and

FIG. 3 is a schematic perspective view, with parts removed for greater clarity, of a detail of the vehicle of FIGS. 1 and 2.

### DESCRIPTION OF EMBODIMENTS

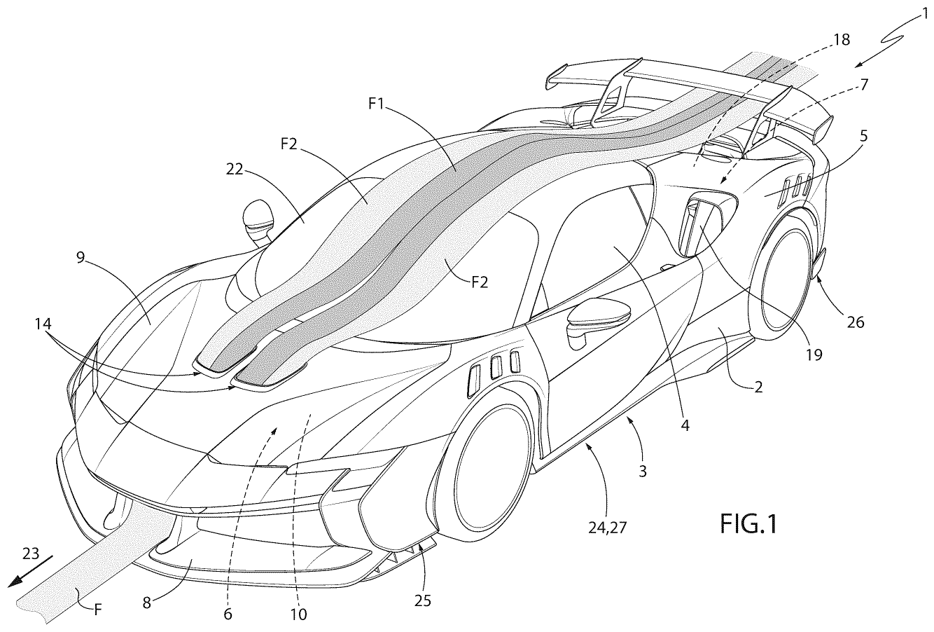

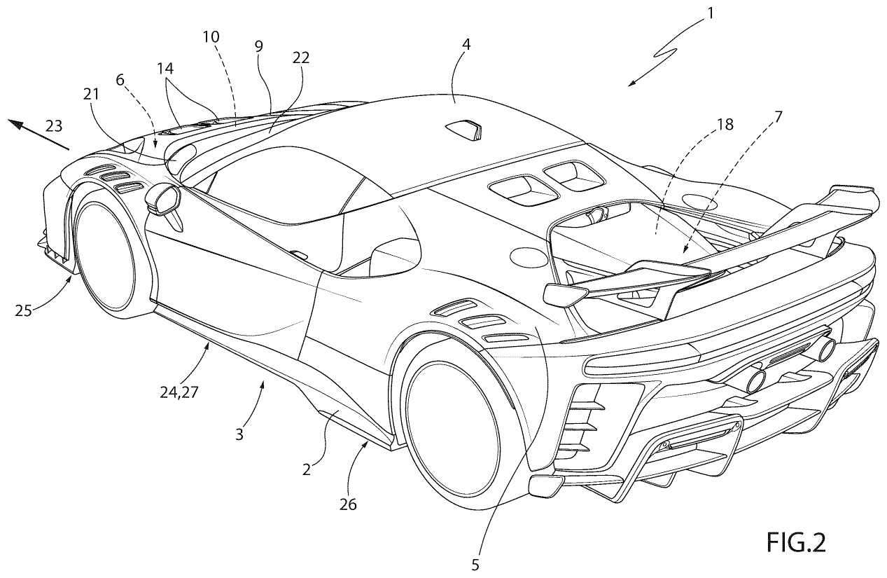

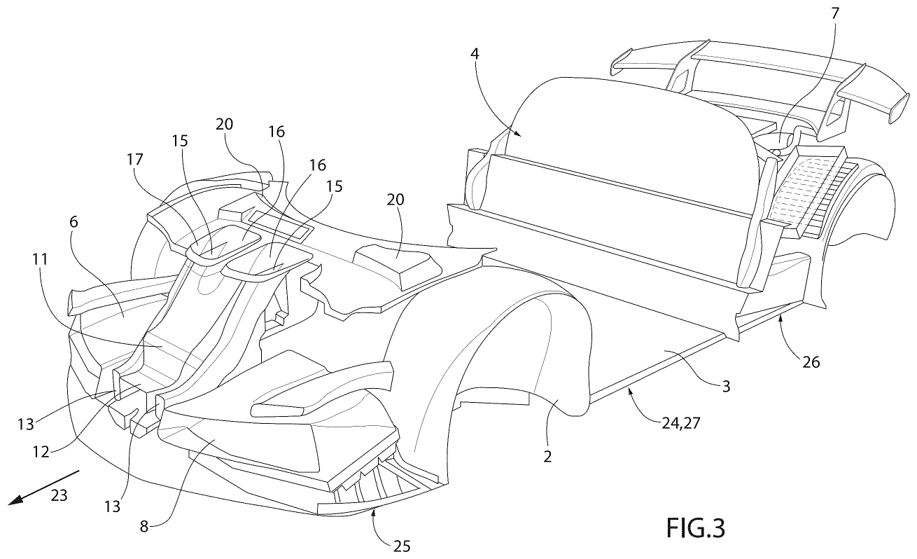

With reference to FIGS. 1, 2 and 3, number 1 indicates, as a whole, a vehicle, specifically a hybrid vehicle, comprising a support frame 2 defining at least part of a lower floor 3 of the vehicle 1, a passenger compartment 4 mounted on the frame 2 and projecting upwards from the floor 3 and an outer body 5.

The vehicle 1 further comprises a front compartment 6 obtained within the body 5 and a rear compartment 7 obtained within the body 5.

The front compartment 6 is delimited by a front bumper 8 and by a front hood 9 and accommodates, on the inside, a first motor 10, specifically an electric motor, and a front radiator 11 to cool the motor 10.

The radiator 11 is arranged along a central duct 12, which extends inside the compartment 6 between the bumper 8 and the hood 9 and opens outwards both through the bumper 8 and through the hood 9.

The compartment 6 also houses, on the inside, two side ducts 13, which are arranged on opposite sides of the duct 12, extend between the bumper 8 and the hood 9, are S-shaped and open outwards both through the bumper 8 and through the hood 9.

The hood 9 has, in this case, two openings 14, each provided with a dividing partition 15 defining two outlet mouths 16, 17, the mouth 16 being an inner mouth communicating with the duct 12 and the mouth 17 being an outer mouth communicating with a duct 13.

In use, the air flow F flowing into the compartment 6 during the normal running of the vehicle 1 is divided into a central air flow F1, which is supplied along the duct 12, through the radiator 11 and to the mouths 16, and into two side air flows F2, which are supplied along the relative ducts 13 and to the relative mouths 17.

When flowing out of the hood 9, the central air flow F1 is laterally delimited by the two side air flows F2, which do not flow through the radiator 11 and, therefore, have a lower temperature than a temperature of the central air flow F1. The rear compartment 7 houses, on the inside, a second engine 18, specifically an internal combustion engine, a known and not shown turbocharger to supply compressed air to the engine 18 and at least one heat exchanger (not shown), commonly known as “intercooler”, to cool the compressed air supplied by the turbocharger (not shown) to the engine 18. The vehicle 1 is further provided with a pair of intake mouths 19, which are obtained between the passenger compartment 4 and the rear compartment 7 and open outwards through the body 5 in the area of the side flanks of the vehicle 1 to supply air to the heat exchanger (not shown).

The vehicle 1 further comprises a known air heating/conditioning system, which is not shown herein, to supply hot/conditioned air into the passenger compartment 4, a first pair of intake mouths 20 obtained under the hood 9 to supply air into the passenger compartment 4 through the air heating/conditioning system and a second pair of intake mouths 21 obtained along a lower edge of a front windshield 22 to supply air into the passenger compartment 4 through the air heating/conditioning system.

The mouths 19, 20, 21 of each pair of mouths 19, 20, 21 are substantially symmetrical relative to a longitudinal symmetry plane of the vehicle and are arranged so that the distance between the mouths 17, measured crosswise to a forward moving direction 23 of the vehicle 1, is smaller than the distance between the mouths 19, the distance between the mouths 20 and the distance between the mouths 21, which are also measured crosswise to the direction 23.

As a consequence, the air flows F2, namely the air flows at a lower temperature, extend between the mouths 19, 20, 21 and prevent the air flow F1, namely the air flow at a higher temperature, from reaching the mouths 19, 20, 21 and from jeopardizing the correct operation of the radiator 11 and of the aforesaid heat exchanger (not shown).

The vehicle 1 finally comprises an aerodynamic bottom 24, which is fixed to the frame 2, defines part of the floor 3 and comprises, in turn, a front bottom 25, which is mounted in the area of the front compartment 6, a rear bottom 26, which is mounted in the area of the rear compartment 7, and a central bottom 27, which is mounted in the area of the passenger compartment 4.

At least the front bottom 25 is closed so as to exert a relatively high vertical load upon the vehicle 1.

1. A vehicle comprising a support frame (2); a passenger compartment (4); an outer body (5); a front compartment (6) obtained within the outer body (5) and delimited by a front bumper (8) and by a front hood (9); a rear compartment (7) obtained within the outer body (5); a central duct (12), which extends between the front bumper (8) and the front hood (9) and opens outwards both through the front bumper (8) and through the front hood (9); and a front radiator (11) mounted in the front compartment (6) and along the central duct (12); and characterized in that it further comprises two side ducts (13), which are arranged on opposite sides of the central duct (12), extend between the front bumper (8) and the front hood (9) and open outwards both through the front bumper (8) and through the front hood (9) so as to confine a central air flow (F1) flowing along the central duct (12) between two side air flows (F2) flowing along the side ducts (13).

2. The vehicle according to claim 1, wherein the two side ducts (13) are arranged on opposite sides of the front radiator (11).

3. The vehicle according to claim 1, wherein each side duct (13) is substantially S-shaped.

4. The vehicle according to claim 1, and further comprising at least one pair of first intake mouths (20, 21) to connect the passenger compartment (4) and the outside to one another and to allow environment air to flow into the passenger compartment (4); the first intake mouths (20, 21) of each pair of first intake mouths (20, 21) being obtained on the outside of the side ducts (13).

5. The vehicle according to claim 4, and further comprising an air heating/conditioning system interposed between the first intake mouths (20, 21) and the passenger compartment (4) in order to heat/condition the air flowing through the first intake mouths (20, 21).

6. The vehicle according to claim 1, and further comprising a main engine (18), in particular an internal combustion engine, housed in the rear compartment (7), a compressor to supply compressed air to the main engine (18), at least one heat exchanger to cool the air supplied by the compressor to the main engine (18) and at least one pair of second intake mouths (19) obtained between the passenger compartment (4) and the rear compartment (7) in order to connect the heat exchanger and the outside to one another; the second intake mouths (19) of each pair of second intake mouths (19) being obtained on the outside of the side ducts (13).

7. The vehicle according to claim 1, wherein the front hood (9) has at least one central opening (16) for the passage of the central air flow (F1) and, for each side duct (13), a respective side opening (17) for the passage of the relative side air flow (F2).

8. The vehicle according to claim 4, wherein the intake mouths (19, 20, 21) of each pair of intake mouths (19, 20, 21) are substantially symmetrical relative to a longitudinal symmetry plane of the vehicle and are arranged at a distance from one another, measured crosswise to a forward moving direction (23) of the vehicle, that is greater than a distance between the side openings (17), which is also measured crosswise to the forward moving direction (23).

9. The vehicle according to claim 1, and further comprising an auxiliary motor (10), in particular an electric motor, associated with and cooled by the front radiator (11).

10. The vehicle according to claim 1, wherein the central duct (12) and the side ducts (13) extend through the front compartment (6).
